(19) United States
(12) Patent Application Publication
(10) Pub. No.: US 2014/0236714 A1
(43) Pub. Date: Aug. 21, 2014

(54) ELECTRONIC RECEIPT SYSTEM, ELECTRONIC RECEIPT MANAGEMENT SERVER, AND INFORMATION PROCESSING APPARATUS

(71) Applicants: HAKUHODO INC., Tokyo (JP); TOSHIBA TEC KABUSHIKI KAISHA, Tokyo (JP)

(72) Inventors: Makoto FUKASAWA, Gunma (JP); Taro ANDO, Shizuoka (JP); Keiichi HASEGAWA, Tokyo (JP); Satoru ISHIHARA, Osaka (JP); Tsuyoshi GOTANDA, Tokyo (JP); Kazuhisa ARAKAWA, Tokyo (JP)

(73) Assignees: HAKUHODO INC., Tokyo (JP); TOSHIBA TEC KABUSHIKI KAISHA, Tokyo (JP)

(21) Appl. No.: 14/186,485

(22) Filed: Feb. 21, 2014

(30) Foreign Application Priority Data
Feb. 21, 2013 (JP) 2013-032533

(51) Int. Cl. G06Q 30/02

(52) U.S. Cl. CPC G06Q 30/0253
USPC 705/14.51

(57) ABSTRACT

An electronic receipt system generates, in association with a code of a shopper, electronic receipt information related to commodity sales data processing, stores the generated electronic receipt information in a storing unit, and stores additional information associated with commodity information and a specific condition in the storing unit. The electronic receipt system causes an information processing apparatus associated with the code of the shopper to display the electronic receipt information associated with the code and a selectable object for instructing a start of processing for the additional information related to the commodity information included in the electronic receipt information in a display unit. The electronic receipt system displays the electronic receipt information and displays. If the selectable object is operated, the electronic receipt system transmits a start signal for the processing for the additional information.

### CROSS-REFERENCE TO RELATED APPLICATION

This application is based upon and claims the benefit of priority of Japanese Patent Application No. 2013-032533 filed on Feb. 21, 2013, the entire contents of which are incorporated herein by reference.

### FIELD

Embodiments described herein relate generally to an electronic receipt system, an electronic receipt management server, and an information processing apparatus.

### BACKGROUND

There has been known a mechanism called electronic receipt for electronically delivering a receipt or a voucher, which is handed over to a shopper from a store during a commodity settlement, to a portable terminal or the like of the shopper.

This is beneficial for the shopper because it is possible to, for example, automatically electronically keep household accounts by converting the receipt into electronic data in this way. This is also beneficial for a store that introduces the electronic receipt because it is possible to reduce consumption of receipt sheets by introducing the electronic receipt.

In addition, it is also known to perform product sales promotion and advertisement by electronically attaching a coupon or the like related to a purchased commodity to the electronic receipt.

Incidentally, as one of sales promotion campaigns of a consumer product manufacturer or the like, campaign stickers (purchase certificates) are affixed to target commodities and a shopper inputs a sticker number (a commodity ID and a check digit) described on the campaign sticker to an application page designated by a URL (Uniform Resource Locator) and applies for the campaign. However, with such an application type campaign, for the consumer product manufacturer or the like that manufactures the campaign target commodities, sales promotion expenses including production costs of the campaign stickers and costs for affixing the campaign stickers to the campaign target commodities are not negligible.

### DESCRIPTION OF THE DRAWINGS

FIG. 1 is a configuration diagram showing the overall configuration of an electronic receipt system according to an embodiment;

FIGS. 2A to 2D are transition charts showing a transition example of a screen in member registration of a customer;

FIG. 3 is a block diagram showing the main part configuration of a portable terminal;

FIG. 4 is a block diagram showing the main part configuration of a POS terminal;

FIG. 5 is a block diagram showing the main part configuration of an electronic receipt server;

FIG. 6 is a block diagram showing the main part configuration of an electronic receipt management server;

FIG. 7 is a functional block diagram related to electronic receipt processing in the POS terminal;

FIG. 8 is a flowchart for explaining a flow of electronic receipt processing;

FIG. 9 is a flowchart for explaining a flow of information transmission processing in the electronic receipt server;

FIG. 10 is a functional block diagram related to electronic receipt management processing and commodity information transmission processing in the electronic receipt management server;

FIG. 11 is a flowchart for explaining a flow of the electronic receipt management processing and the commodity information transmission processing;

FIG. 12 is a functional block diagram related to electronic receipt reception processing and electronic receipt viewing processing in the portable terminal;

FIG. 13 is a flowchart for explaining a flow of the electronic receipt reception processing and electronic receipt viewing processing;

FIG. 14 is a front view showing a display example in the portable terminal;

FIG. 15 is a front view showing a display example in the portable terminal;

FIG. 16 is a front view showing a display example in the portable terminal;

FIG. 17 is a front view showing a display example in the portable terminal;

FIG. 18 is a front view showing a display example in the portable terminal;

FIG. 19 is a front view showing a display example in the portable terminal;

FIGS. 20A to 20C are screen transition charts showing a flow of campaign application processing;

FIGS. 21A to 21D are screen transition charts showing a flow of another kind of campaign application processing;

FIG. 22 is a configuration diagram showing the overall configuration of an electronic receipt system according to a modification; and

FIG. 23 is a block diagram showing the main part configuration of a POS terminal according to the modification.

### DETAILED DESCRIPTION

It is an object of embodiments to provide an electronic receipt system, an electronic receipt management server, and an information processing apparatus that substantially reduce sales expenses for a campaign.

In general, according to an embodiment, there is provided an electronic receipt system including an electronic-receipt generating unit; an electronic-receipt managing unit; an additional-information managing unit; an electronic-receipt transmitting unit, an electronic-receipt display unit; and a processing unit. The electronic-receipt generating unit generates, in association with a code of a shopper, electronic receipt information related to commodity sales data. The electronic-receipt managing unit stores the electronic receipt information generated by the electronic-receipt generating unit in a storing unit. The additional-information managing unit stores additional information associated with commodity information and a specific condition in the storing unit. The electronic-receipt transmitting unit transmits, to an information processing apparatus associated with the code of the shopper, the electronic receipt information associated with the code and the additional information related to the commodity information included in the electronic receipt information. The electronic-receipt display unit displays the electronic receipt information transmitted to the information processing apparatus by the electronic-receipt transmitting unit and displays a selectable object for instructing a start of processing for the additional information associated with the commodity information included in the electronic receipt information. If the selectable object displayed by the electronic-receipt display unit is operated, the processing unit transmits a start signal for the processing for the additional information.

According to another embodiment, there is provided an electronic receipt management server including a receiving unit, an electronic-receipt managing unit, an additional-information managing unit, and an electronic-receipt transmitting unit. The receiving unit receives electronic receipt information related to commodity sales data. The electronic-receipt managing unit stores the electronic receipt information received by the receiving unit in a storing unit. The additional-information managing unit stores additional information associated with commodity information and a specific condition in the storing unit. The electronic-receipt transmitting unit transmits, to an information processing apparatus associated with a code of a shopper, the electronic receipt information associated with the code and the additional information related to the commodity information included in the electronic receipt information.

According to still another embodiment, there is provided an information processing apparatus including an electronic-receipt receiving unit, an electronic-receipt display unit, and a processing unit. The electronic-receipt receiving unit receives electronic receipt information related to commodity sales data and additional information associated with commodity information and a specific condition included in the electronic receipt information from an electronic receipt management server that stores the electronic receipt information. The electronic-receipt display unit displays the electronic receipt information received by the electronic-receipt receiving unit on a display unit and displays a selectable object for instructing a start of processing for the additional information associated with the commodity information and the specific condition included in the electronic receipt information on the display unit. If the selectable object displayed by the electronic-receipt display unit is operated via an operation unit, the processing unit transmits a start signal for the processing for the additional information.

An embodiment is explained with reference to the drawings.

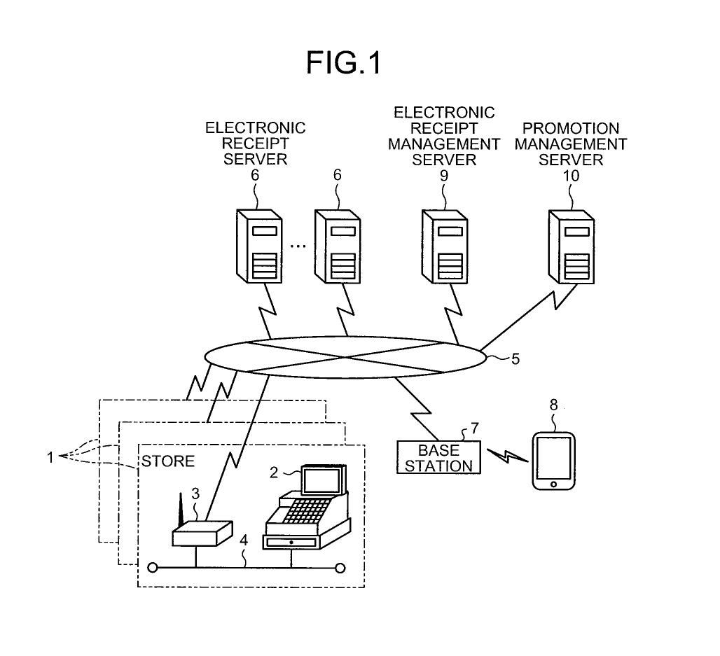

FIG. 1 is a configuration diagram showing the overall configuration of an electronic receipt system according to the embodiment. As shown in FIG. 1, in a store 1, a POS (Point of Sales) terminal 2 (only one terminal 2 is shown in FIG. 1, however, a plurality of terminals 2 may be provided), which is a commodity sales data processing apparatus that executes commodity sales data processing, and a router 3 are set. The POS terminal 2 and the router 3 are connected by a store LAN (Local Area Network) 4. The router 3 is a device for connecting the store LAN 4 and a network 5, which is the Internet or a VPN (Virtual Private Network). Although not specifically shown in the figure, a store server that manages the POS terminal 2 may be provided in the store 1.

An electronic receipt server 6 is connected to the network 5. A plurality of the electronic receipt servers 6 are provided in units of a company that operates stores or chain stores (hereinafter referred to as stores). The electronic receipt server 6 functions as a receipt management server for companies that manage electronic receipt information for each of companies that operate stores. To the electronic receipt server 6, a head office server of a POS system having functions of sales management, sales analysis, stock management, and the like of the companies that operate the stores may be applied.

A portable terminal 8 is connected to the network 5 via a base station 7 that performs radio communication according to a standard such as Wi-Fi (Wireless Fidelity). The portable terminal 8 is an information processing apparatus such as a smart phone, a cellular phone, a PDA (Personal Digital Assistant), or a tablet computer installed with a Web browser. An information processing apparatus such as a personal computer may be applied instead of the portable terminal 8.

Further, an electronic receipt management server 9 functioning as a receipt management server for customers, which collectively manages electronic receipt information of various companies that operate stores, is also connected to the network 5. A customer registered as a member in advance can access the electronic receipt management server 9 and obtain electronic receipt information using the portable terminal 8 through the network 5. The electronic receipt management server 9 is managed by, for example, a third party organization other than companies, the electronic receipt information of which is managed by the electronic receipt server 6. The third party organization or the like may manage the electronic receipt server 6 as well. A service (an application) for collectively managing, using a plurality of company codes, the electronic receipt information for each of the companies indicating the companies, which manage the stores, may be provided in a form of, for example, SaaS (Software as a Service), which is a kind of cloud computing.

In addition, a promotion management server 10 is also connected to the network 5. The promotion management server 10 includes an entry master that manages an application history for each of campaign types in association with member codes.

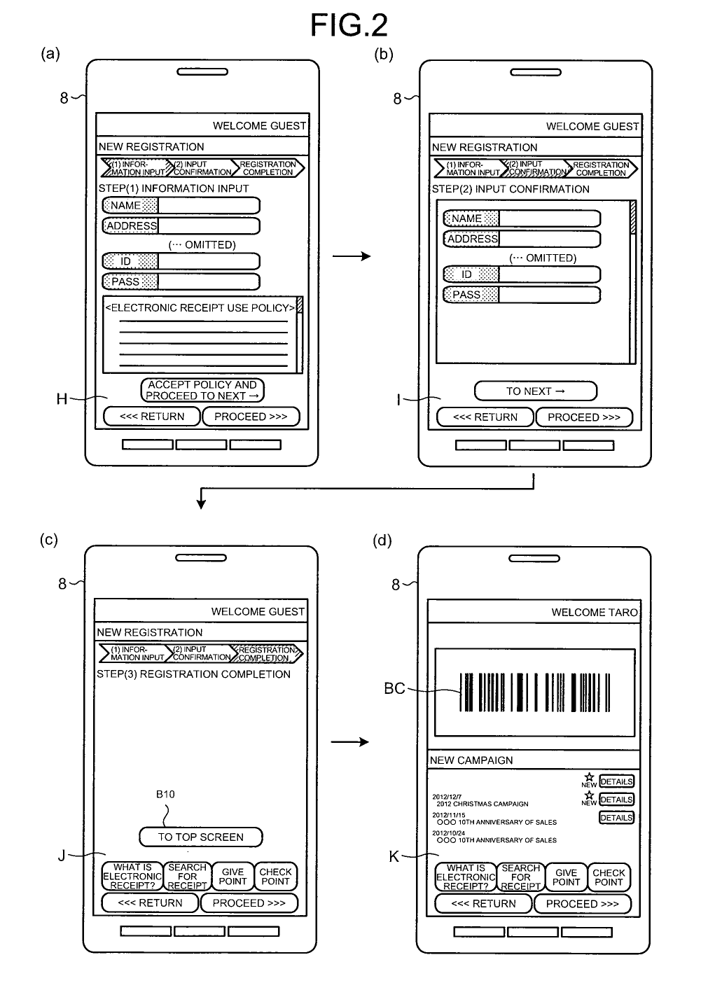

Member registration of a customer is performed, for example, as explained below. FIGS. 2A to 2D are transition charts showing a transition example of a screen in the member registration of a customer. The customer transmits a blank mail to a member management server (not shown in the figure) from the portable terminal 8 through the network 5. The member management server transmits a URL (Uniform Resource Locator) indicating a page for the member registration to a received mail address. The customer accesses the URL indicating the page for the member registration from the portable terminal 8, causes the portable terminal 8 to display an input screen H (see FIG. 2A), and inputs items necessary for the member registration. An input confirmation screen I is displayed on the portable terminal 8 after the input of the necessary items by the customer to the portable terminal 8 ends (see FIG. 2B). After confirmation of the input by the customer, member registration in a member master is executed. Thereafter, the member management server delivers a member registration completion mail including a member code and a password to the portable terminal 8. Consequently, the member registration is completed. FIG. 2C is a registration completion screen J displayed on the portable terminal 8 after the registration completion. A “top screen display” button B10 is provided on the registration completion screen J. The customer operates the “top screen display” button B10, whereby the portable terminal 8 displays a top screen K shown in FIG. 2D.

After the member registration explained above, on the top screen K shown in FIG. 2D, a member code of the customer, who uses an electronic receipt, is displayed as a barcode BC. The customer presents the barcode BC displayed on the portable terminal 8 to a store clerk during a transaction settlement in the store 1. The store clerk reads, with a scanner (not shown in the figure) connected to the POS terminal 2, the barcode BC displayed on the portable terminal 8. Consequently, the member code of the customer is associated with electronic receipt information generated after the settlement by the commodity sales data processing in the POS terminal 2.

In the electronic receipt system having such a configuration, electronic receipt information indicating content of a settlement generated by the commodity sales data processing performed in the POS terminal 2 of the store 1 is transmitted to the electronic receipt management server 9 via the network 5 and the electronic receipt server 6 and opened to the public on a Web. Therefore, the portable terminal 8 implemented with the Web browser can download the electronic receipt information opened to the public on the Web to the portable terminal 8 and view the electronic receipt information on the Web browser by designating a URL (Uniform Resource Locator). Application software for viewing the electronic receipt information may be installed in the portable terminal 8 to view the electronic receipt information.

In view of the above, the configurations of the units included in the electronic receipt system in this embodiment are explained below.

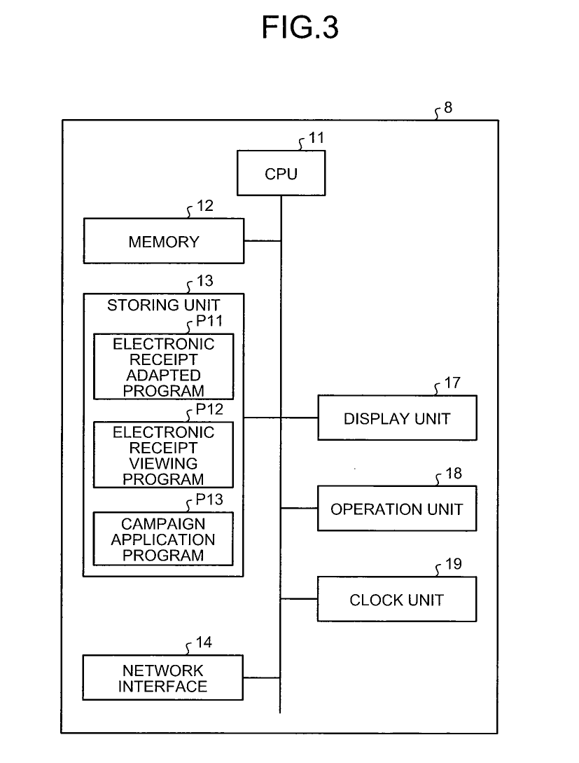

First, the main part configuration of the portable terminal 8, which is an information processing apparatus, is explained with reference to a block diagram of FIG. 3. As shown in FIG. 3, the portable terminal 8 includes a CPU (Central Processing Unit) 11 configuring a control unit main body, a memory 12 for temporarily storing data, a storing unit 13 readable and writable according to a command from the CPU 11 and configured to store a computer program, data, and the like, a network interface 14 connected to various public networks including the network 5, a display unit 17 capable of displaying various kinds of information, an operation unit 18 for operating the portable terminal 8, and a clock unit 19 configured to measure time. The operation unit 18 is a touch panel laminated on the display unit 17 or keys provided on a housing.

The storing unit 13 is installed in advance with, besides the Web browser for viewing various kinds of information (contents) opened to the public on the Web, an electronic receipt adapted program P11 for receiving electronic receipt information generated after a settlement by the commodity sales data processing from the electronic receipt management server 9 and an electronic receipt viewing program P12 for viewing the received electronic receipt information.

In addition, the storing unit 13 is installed in advance with a campaign application program P13 for applying for an application type campaign.

The electronic receipt adapted program P11, the electronic receipt viewing program P12, and the campaign application program P13 executed by the portable terminal 8 are provided while being recorded in a computer-readable recording medium such as a CD-ROM, a flexible disk (FD), a CD-R, or a DVD (Digital Versatile Disk) as a file in an installable form or an executable form.

The electronic receipt adapted program P11, the electronic receipt viewing program P12, and the campaign application program P13 executed by the portable terminal 8 may be stored on a computer connected to a network such as the Internet and provided by being downloaded through the network. The electronic receipt adapted program P11, the electronic receipt viewing program P12, and the campaign application program P13 executed by the portable terminal 8 may be provided or distributed through the network such as the Internet.

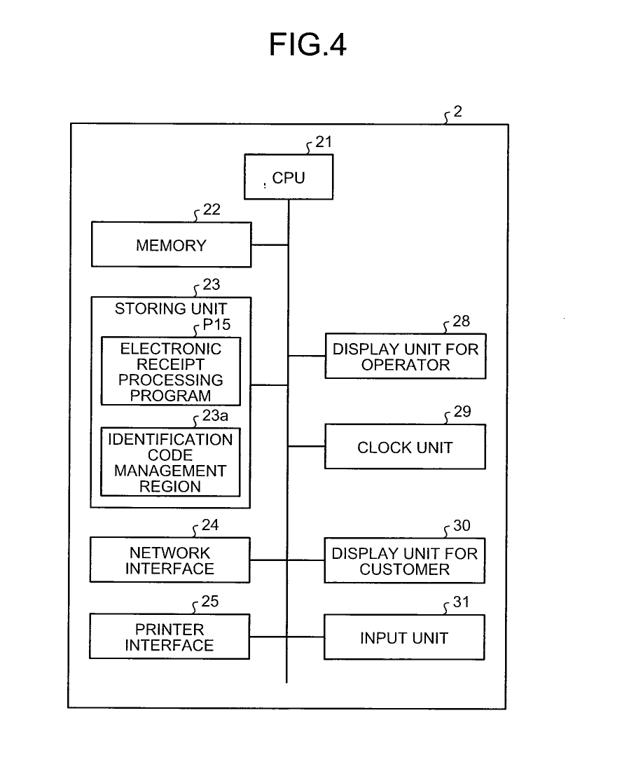

The main part configuration of the POS terminal 2, which is a commodity sales data processing apparatus, is explained with reference to a block diagram of FIG. 4. As shown in FIG. 4, the POS terminal 2 includes a CPU (Central Processing Unit) 21 configuring a control unit main body, a memory 22 for temporarily storing data, a storing unit 23 readable and writable according to a command from the CPU 21 and configured to store a computer program, data, and the like, a network interface 24 connected to the store LAN 4, a printer interface 25 to which a printer is connected, a display unit for operator 28 for displaying various kinds of information to an operator, a clock unit 29 configured to measure time, a display unit for customer 30 for displaying various kinds of information to a customer, and an input unit 31 for operating the POS terminal 2.

In the storing unit 23, an identification code management region 23a is secured that serves as a region for storing in advance, in addition to a POS number of the POS terminal 2, a company code (an identification code of a company that operates stores), a business type and business status code, a store code indicating the store 1 in which the POS terminal 2 is set, and the like. The business type and business status code is a code (a classification code) for distinguishing a business type and a business status of a store as, for example, a convenience store, a supermarket, a department store, a pharmacy, a restaurant, an eating house, or the like. Such a business type and a business status can be arbitrarily changed according to a preference of a user. The company code (the identification code of the company that operates stores) and the business type and business status code may be registered in the electronic receipt server 6.

The storing unit 23 is installed in advance with, besides software for executing various POS jobs including the commodity sales data processing, an electronic receipt processing program P15 for processing electronic receipt information electronically processed instead of a receipt or a voucher printed and issued in the commodity sales data processing.

The electronic receipt processing program P15 executed by the POS terminal 2 is provided while being recorded in a computer-readable recording medium such as a CD-ROM, a flexible disk (FD), a CR-R, or a DVD (Digital Versatile Disk) as a file in an installable or executable form.

The electronic receipt processing program P15 executed by the POS terminal 2 may be stored on a computer connected to a network such as the Internet and provided by being downloaded through the network. The electronic receipt processing program P15 executed by the POS terminal 2 may be provided or distributed through the network such as the Internet.

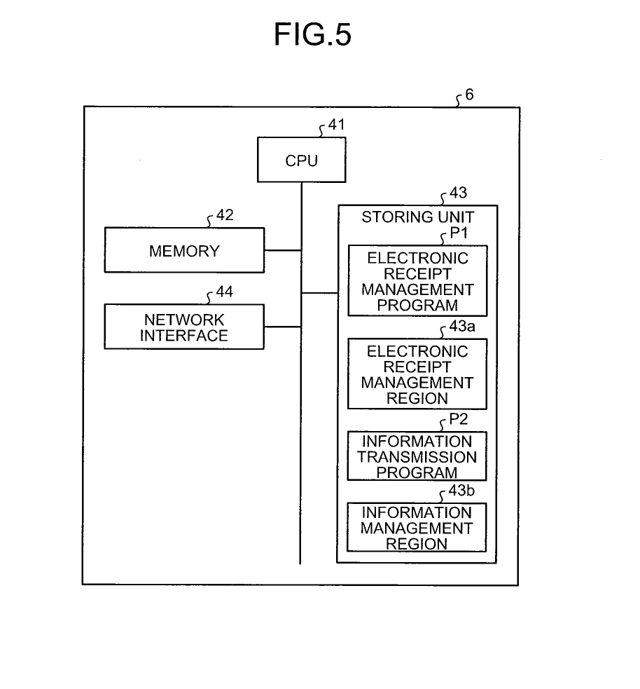

The main part configuration of the electronic server 6 functioning as a receipt management server for company is explained with reference to a block diagram of FIG. 5. The electronic receipt server 6 includes a CPU (Central Processing Unit) 41 configuring a control unit main body, a memory 42 for temporarily storing data, a storing unit 43 readable and writable according to a command from the CPU 41 and configured to store a computer program, data, and the like, and a network interface 44 connected to the network 5.

In the storing unit 43, an electronic receipt management region 43a is secured as a region for storing electronic receipt information for each of companies that operate stores. The electronic receipt information includes a company code (an identification code of a company that operates stores), a business type and business status code, a store code, a member code of a shopper, a POS number of the POS terminal 2, a receipt number, commodity sales data, and the like.

The storing unit 43 is installed in advance with an electronic receipt management program P1 for managing, in the electronic receipt management region 43a, electronic receipt information received from the POS terminals 2 of the stores 1.

The storing unit 43 is also installed in advance with an information transmission program P2 for transmitting the electronic receipt information managed in the electronic receipt management region 43a to the electronic receipt management server 9.

Further, the storing unit 43 is provided with an information management region 43b in which various kinds of additional information are stored in association with a desired commodity (commodity code), a member (a member code), a company (a company code), and a store (a store code). The additional information is, for example, campaign information related to a campaign associated with desired commodity information and a specific condition (e.g., a specific company that operates stores, a specific district, a specific store, or a specific time) and is access information such as a URL linked to a Web page associated with a campaign of a company, a URL linked to a Web page associated with a CM of a company, or a URL linked to a coupon of a company.

The electronic receipt management program P1 and the information transmission program P2 executed by the electronic receipt server 6 are provided while being recorded in a computer-readable recording medium such as a CD-ROM, a flexible disk (FD), a CD-R, or a DVD (Digital Versatile Disk) as a file in an installable form or an executable form.

The electronic receipt management program P1 and the information transmission program P2 executed by the electronic receipt server 6 may be stored on a computer connected to a network such as the Internet and provided by being downloaded through the network. The electronic receipt management program P1 and the information transmission program P2 executed by the electronic receipt server 6 may be provided or distributed through the network such as the Internet.

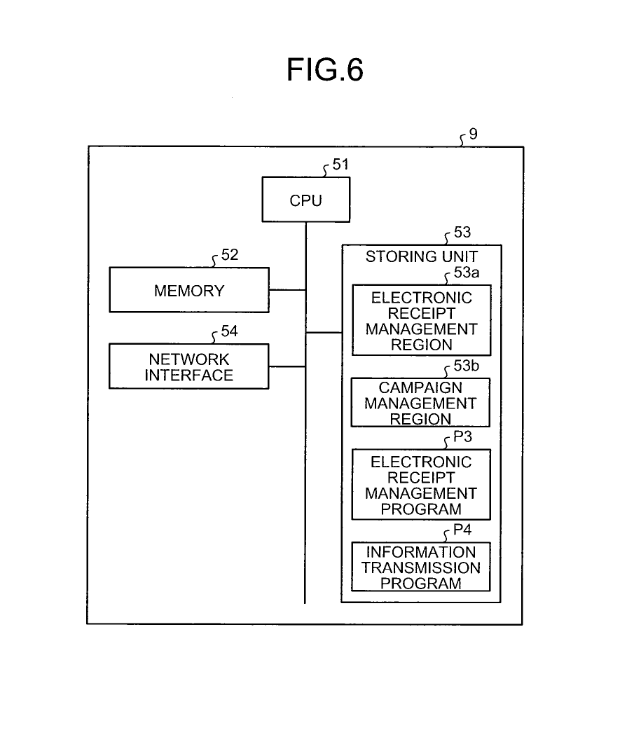

The main part configuration of the electronic receipt management server 9 functioning as a receipt management server for customer is explained with reference to a block diagram of FIG. 6. The electronic receipt management server 9 includes a CPU (Central Processing Unit) 51 configuring a control unit main body, a memory 52 for temporarily storing data, a storing unit 53 readable and writable according to a command from the CPU 51 and configured to store a computer program, data, and the like, and a network interface 54 connected to the network 5.

In the storing unit 53, an electronic receipt management region 53a is secured as a region for collectively storing electronic receipt information of various companies that operate stores. More specifically, in the electronic receipt management area 53a, electronic receipt information and additional information (campaign information) of the various companies that operate stores are managed for each of members.

The electronic receipt information includes a member code, a company code (an identification code of a company that operates stores), a store code, a POS number of the POS terminal 2, a receipt number, and commodity sales data (including date and time data). Therefore, for example, a consumer product manufacturer can acquire unique certification information of a purchased commodity related to the manufacturer under a specific condition (e.g., limited to a specific company that operates stores, limited to a specific district, or limited to a specific time) from the electronic receipt information. The consumer product manufacturer is a manufacturer of foods, beverages, clothes, cosmetics, drugs, household goods, or the like.

In the storing unit 53, a campaign management region 53b is secured as a region for storing and managing purchase certification information (details are explained below) included in application data received for each of campaigns explained below.

The storing unit 53 is installed in advance with an electronic receipt management program P3 for managing, in the electronic receipt management region 53a, additional information and electronic receipt information received from the electronic receipt servers 6 of companies.

The storing unit 53 is installed in advance with an information transmission program P4 for transmitting electronic receipt information and additional information of a desired commodity to the portable terminal 8.

The electronic receipt management program P3 and the information transmission program P4 executed by the electronic receipt management server 9 are provided while being recorded in a computer-readable recording medium such as a CD-ROM, a flexible disk (FD), a CD-R, or a DVD (Digital Versatile Disk) as a file in an installable form or an executable form.

The electronic receipt management program P3 and the information transmission program P4 executed by the electronic receipt management server 9 may be stored on a computer connected to a network such as the Internet and provided by being downloaded through the network. The electronic receipt management program P3 and the information transmission program P4 executed by the electronic receipt management server 9 may be provided or distributed through the network such as the Internet.

The operations of the units included in the system in this embodiment are explained.

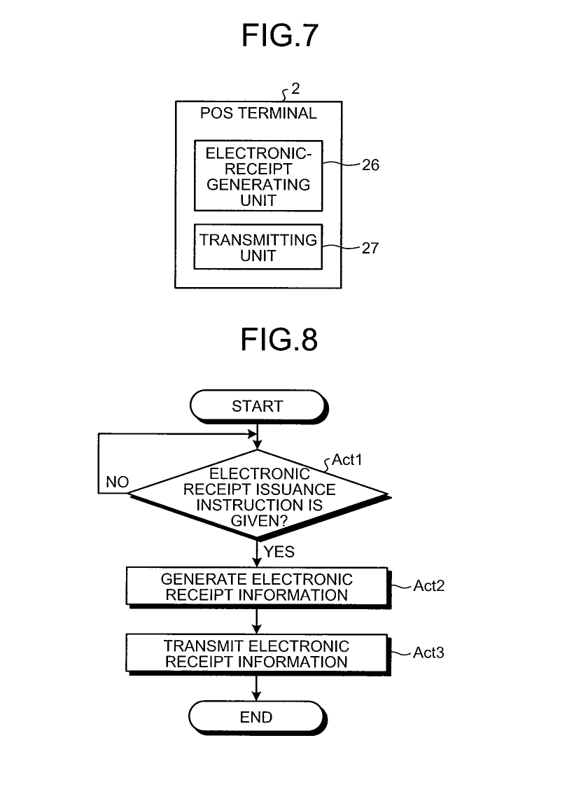

First, electronic receipt processing executed by the CPU 21 of the POS terminal 2 operating according to the electronic receipt processing program P15 is explained with reference to a functional block diagram of FIG. 7 and a flowchart of FIG. 8.

As shown in FIG. 7, the electronic receipt processing program P15 executed by the POS terminal 2 has a module configuration including an electronic-receipt generating unit 26 and a transmitting unit 27. As actual hardware, the CPU 21 reads out the electronic receipt processing program P15 from the storing unit 23 and executes the electronic receipt processing program P15, whereby the electronic-receipt generating unit 26 and the transmitting unit 27 are loaded onto the memory 22 and the units are generated on the memory 22.

The electronic-receipt generating unit 26 generates, in association with a member code of a shopper, electronically-processed electronic receipt information on the basis of commodity sales data including a company code indicating a company that operates stores and processed in the commodity sales data processing.

The transmitting unit 27 transmits the electronic receipt information generated by the electronic-receipt generating unit 26 to the electronic receipt server 6 that manages the electronic receipt information in units of the company corresponding to the company code.

As shown in FIG. 8, if a closing operation key or the like for starting closing processing for a commodity transaction is input, the CPU 21 (the electronic-receipt generating unit 26) of the POS terminal 2 determines whether an input of a member code, confirmation of presence or absence of electronic receipt issuance, and an electronic receipt issuance instruction corresponding to settlement processing corresponding to closing operation are given (Act 1).

In order to show the electronic receipt issuance instruction, a customer, who is a member, displays a barcode including a code serving as a trigger on the display unit 17 of the portable terminal 8. A store clerk or the customer, who is a member, himself or herself reads the barcode with the input unit 31 (e.g., a barcode scanner) of the POS terminal 2.

If the CPU 21 (the electronic-receipt generating unit 26) of the POS terminal 2 determines that the electronic receipt issuance instruction is given (YES in Act 1), the CPU 21 transmits commodity transaction data to the head office server, extracts, separately from the commodity transaction data, on the basis of information concerning a commodity and information concerning a settlement registered during a settlement by the commodity sales data processing, a company code (an identification code of a company that operates stores), a business type and business status code, a store code, a member code of a shopper, a POS number of the POS terminal 2, a receipt number, commodity sales data, and the like from a commodity sales data management region provided in the memory 22, and generates electronic receipt information (Act 2).

Subsequently, the CPU 21 (the transmitting unit 27) of the POS terminal 2 connects to the store LAN 4 and the network 5 via the network interface 24, transmits the generated electronic receipt information to the electronic receipt server 6 (Act 3), and ends the processing. If the CPU 21 determines that the electronic receipt issuance instruction is not given, the CPU 21 prints and issues a paper receipt, transmits the commodity transaction data to the head office server, and ends the processing.

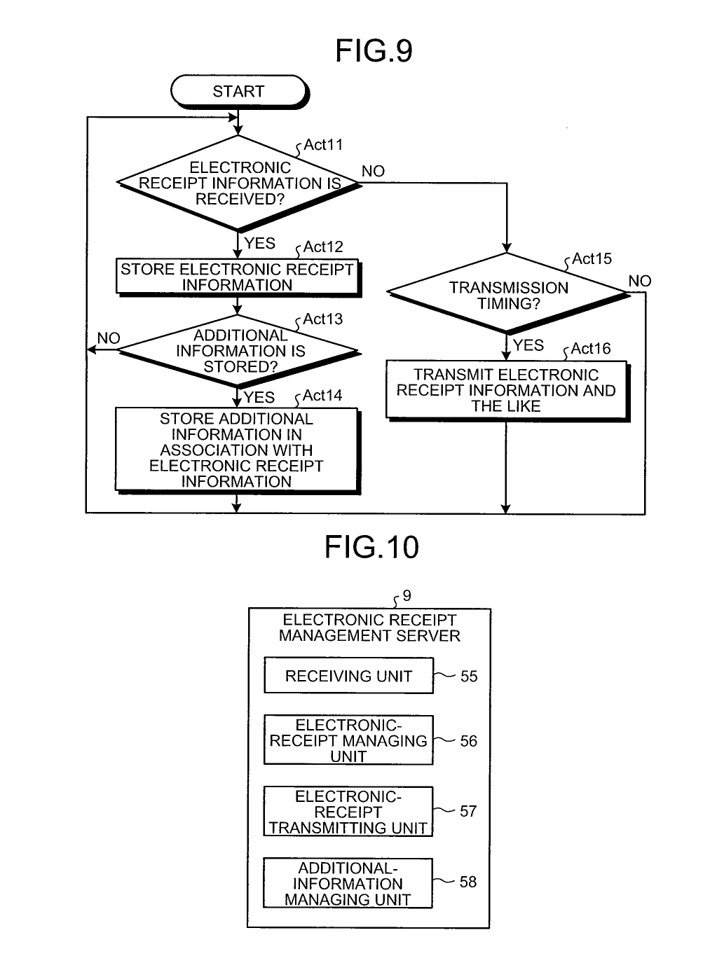

A flow of electronic receipt management processing executed by the CPU 41 of the electronic receipt server 6 operating according to the electronic receipt management program P1 and information transmission processing executed by the CPU 41 operating according to the information transmission program P2 is explained with reference to a flowchart of FIG. 9.

If the CPU 41 of the electronic receipt server 6 receives electronic receipt information transmitted from the POS terminal 2 via the network interface 44 (Yes in Act 11), the CPU 41 stores the electronic receipt information in the electronic receipt management region 43a of the storing unit 43 as electronic receipt information for each of companies (Act 12). That is, the CPU 41 of the electronic receipt server 6 functions as means for storing and managing the electronic receipt information in the storing unit 43 in units of a company corresponding to a company code.

Subsequently, the CPU 41 of the electronic receipt server 6 determines whether additional information related to the stored electronic receipt information is stored in the information management region 43b (Act 13). The additional information is information concerning various campaigns and the like associated with a desired commodity (commodity code), a member (a member code), a company (a company code), a store (a store code), and the like.

For example, if the CPU 41 determines that additional information “AAAAA” related to a commodity code “11111” of the electronic receipt information is stored (Yes in Act 13), the CPU 41 stores the electronic receipt information “11111” and the additional information “AAAAA” in association with each other (Act 14).

After storing the received electronic receipt information, when transmission timing set in advance comes (No in Act 11 and Yes in Act 15), the CPU 41 of the electronic receipt server 6 transmits additional information related to the electronic receipt information stored and managed in the electronic receipt management region 43a and the electronic receipt information stored and managed in the information management region 43b to the electronic receipt management server 9 (Act 16) and returns to Act 11.

In the above explanation, the CPU 21 (the electronic-receipt generating unit 26) of the POS terminal 2 generates the electronic receipt information and transmits the electronic receipt information to the electronic receipt server 6. However, the operation of the CPU 21 of the POS terminal 2 is not limited to this. For example, the CPU 21 of the POS terminal 2 may transmit, on the basis of information concerning a commodity and information concerning a settlement registered during a settlement by the commodity sales data processing, a store code, a member code of a shopper, a POS number of the POS terminal 2, a receipt number, commodity sales data, and the like to the electronic receipt server 6. The CPU 41 of the electronic receipt server 6 may add a company code, a business type and business status code, and the like and generate electronic receipt information.

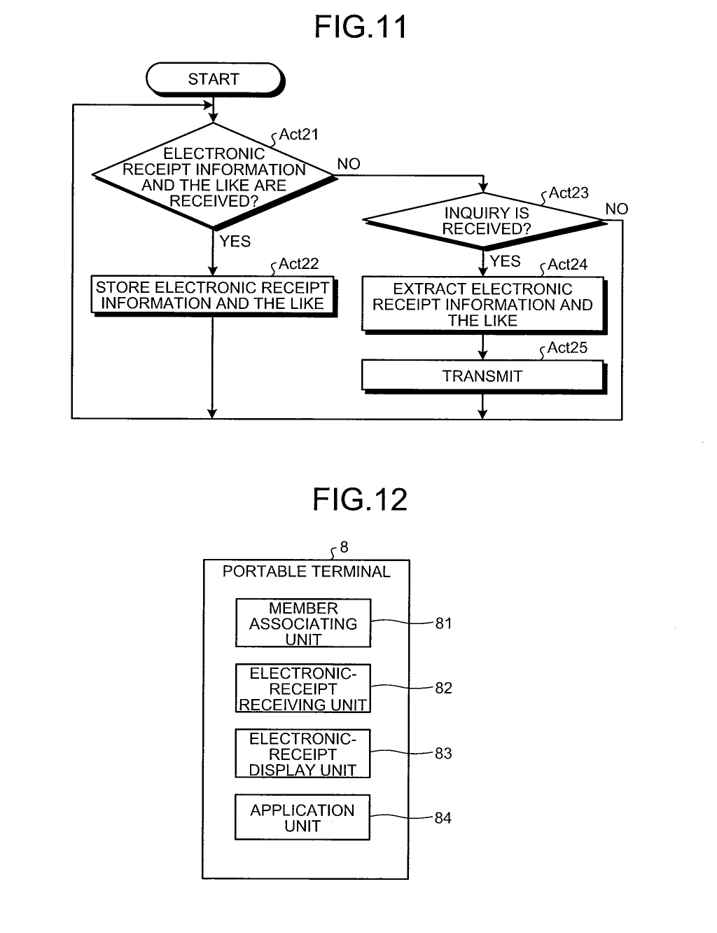

A flow of electronic receipt management processing executed by the CPU 51 of the electronic receipt management server 9 operating according to the electronic receipt management program P3 and commodity information transmission processing executed by the CPU 51 operating according to the information transmission program P4 is explained with reference to a functional block diagram of FIG. 10 and a flowchart of FIG. 11.

As shown in FIG. 10, the electronic receipt management program P3 and the information transmission program P4 executed by the electronic receipt management server 9 have module configuration including a receiving unit 55, an electronic-receipt managing unit 56, an electronic-receipt transmitting unit 57, and an additional-information managing unit 58. As actual hardware, the CPU 51 reads out the electronic receipt management program P3 and the information transmission program P4 from the storing unit 53 and executes the electronic receipt management program P3 and the information transmission program P4, whereby the receiving unit 55, the electronic-receipt managing unit 56, the electronic-receipt transmitting unit 57, and the additional-information managing unit 58 are loaded onto the memory 52 and the units are generated on the memory 52.

The receiving unit 55 receives electronic receipt information in units of a company including a company code indicating a company that operates stores and electronically processed instead of a receipt or a voucher printed and issued in the commodity sales data processing.

The electronic-receipt managing unit 56 stores the electronic receipt information in units of a company received by the receiving unit 55 in the electronic receipt management region 53a of the storing unit 53 and collectively manages the electronic receipt information. The additional-information managing unit 58 stores campaign information related to a campaign associated with a desired commodity and a specific condition (e.g., limited to a specific company that operates stores, limited to a specific district, or limited to a specific time) in the electronic receipt management region 53a of the storing unit 53 and manages the campaign information.

The electronic-receipt transmitting unit 57 acquires electronic receipt information associated with a member code of a predetermined shopper and including at least one or more company codes and additional information (campaign information) related to commodity information included in the electronic receipt information and a specific condition from the electronic receipt management region 53a and transmits the electronic receipt information and the additional information to the portable terminal 8 associated with the member code.

As shown in FIG. 11, the CPU 51 (the receiving unit 55) of the electronic receipt management server 9 determines whether the electronic receipt information and the additional information transmitted from the electronic receipt servers 6 of the companies are received via the network interface 54 (Act 21).

If the electronic receipt information and the additional information are received (Yes in Act 21), the CPU 51 (the electronic-receipt managing unit 56 and the additional-information managing unit 58) of the electronic receipt management server 9 collectively stores the electronic receipt information and the additional information of the various companies in the electronic receipt management region 53a of the storing unit 53 (Act 22).

When an electronic receipt information inquiry is received from the portable terminal 8 (No in Act 21 and Yes in Act 23), the CPU 51 (the electronic-receipt transmitting unit 57) of the electronic receipt management server 9 extracts, according to content of the electronic receipt information inquiry, the additional information and the electronic receipt information stored and managed in the electronic receipt management region 53a (Act 24), then, transmits the additional information and the electronic receipt information to the inquiring portable terminal 8 (Act 25), and returns to Act 21.

Timing for transmitting the electronic receipt information and the additional information to the portable terminal 8 is not only when the electronic receipt information inquiry is received from the portable terminal 8. The CPU 51 may transmit the electronic receipt information and the additional information after collectively storing the electronic receipt information and the additional information in the electronic receipt management region 53a.

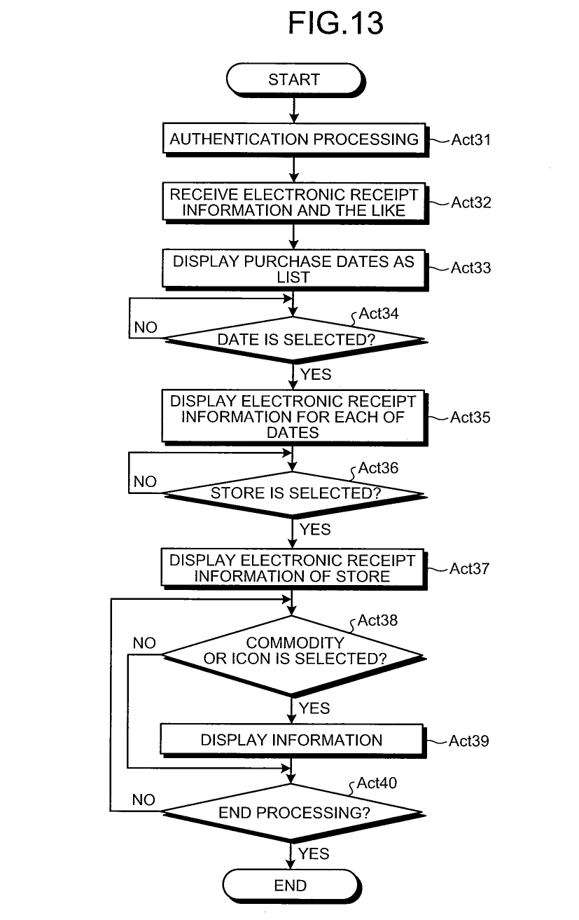

A flow of electronic receipt reception processing executed by the CPU 11 of the portable terminal 8 operating according to the electronic receipt adapted program P11 and electronic receipt viewing program P12 executed by the CPU 11 operating according to the electronic receipt viewing program P12 is explained with reference to a functional block diagram of FIG. 12 and a flowchart of FIG. 13.

As shown in FIG. 12, the electronic receipt adapted program P11 and the electronic receipt viewing program P12 executed by the portable terminal 8 have a module configuration including a member associating unit 81, an electronic-receipt receiving unit 82, an electronic-receipt display unit 83, and an application unit 84 functioning as a processing unit. As actual hardware, the CPU 11 reads out the electronic receipt adapted program P11 and the electronic receipt viewing program P12 from the storing unit 13 and executes the electronic receipt adapted program P11 and the electronic receipt viewing program P12, whereby the member associating unit 81, the electronic-receipt receiving unit 82, the electronic-receipt display unit 83, and the application unit 84 are loaded onto the memory 12 and the units are generated on the memory 12.

The member associating unit 81 associates a member code of a predetermined shopper. The electronic-receipt receiving unit 82 receives electronic receipt information associated with the member code and including at least one or more company codes and additional information (campaign information) related to a campaign associated with commodity information and a specific condition included in the electronic receipt information from the electronic receipt management server 9 that collectively manages the electronic receipt information.

The electronic-receipt display unit 83 aligns, in units of a company code, the electronic receipt information received by the electronic-receipt receiving unit 82 and displays the electronic receipt information on the display unit 17. The electronic-receipt display unit 83 displays an icon, which is a selectable object, for instructing a start of processing of application for the additional information (the campaign information) associated with the commodity information and the specific condition included in the electronic receipt information on the display unit 17. The processing for application can be instructed by selecting the displayed icon. The selectable object is not limited to the icon and may be a URL (Uniform Resource Locator) or the like linked to a page for application.

When the icon displayed by the electronic-receipt display unit 83 is selected by operation via the operation unit 18, the application unit 84 regards the selection operation as at least a part of campaign application. That is, when the displayed icon is selected by operation, the application unit 84 starts processing for campaign application.

As shown in FIG. 13, first, the CPU 11 (the member associating unit 81) of the portable terminal 8 accesses the electronic receipt management server 9 and executes authentication processing according to an input of a member code and a password (Act 31). Consequently, the portable terminal 8 and a member code of a predetermined shopper are associated.

After the authentication, the CPU 11 (the electronic-receipt receiving unit 82) of the portable terminal receives additional information and electronic receipt information stored and managed in the electronic receipt management region 53a of the electronic receipt management server 9 in association with the input member code (Act 32). The additional information and the electronic receipt information may be received by an electronic mail.

Subsequently, the CPU 11 (the electronic-receipt display unit 83) of the portable terminal 8 displays purchase dates included in the electronic receipt information on the display unit 17 as a list (Act 33). By displaying the purchase dates on the display unit 17 as a list in this way, the portable terminal 8 urges a user, who is a shopper, to select information.

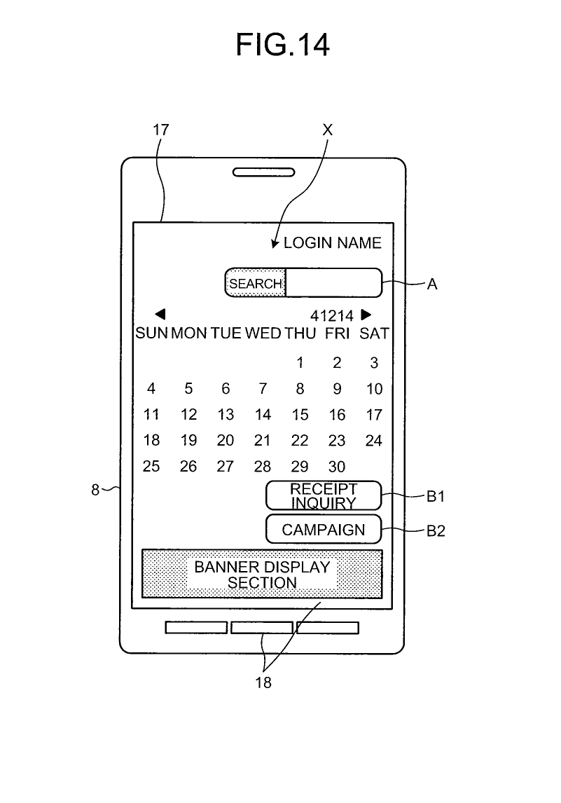

FIG. 14 is a front view showing a display example X in the display unit 17 of the portable terminal 8. As shown in FIG. 14, in the display example X, dates when a user owning the portable terminal 8, which accesses the electronic receipt management server 9, performed shopping in stores of various companies are displayed as a list in different colors in a form of a calendar. The CPU 11 (the electronic-receipt display unit 83) of the portable terminal 8 performs display such that a desired date can be selected by a cursor, which follows an input to the operation unit 18, out of the dates displayed as the list in the different colors.

As shown in FIG. 14, in the display example X, a search window A for designating a word or a keyword serving as a search key is provided. The CPU 11 of the portable terminal 8 may narrow down the electronic receipt information to electronic receipt information including a word or a keyword designated in the search window A.

As shown in FIG. 14, the display example X includes a “receipt inquiry” button B1 for deciding a desired date after selecting the desired date with the cursor. The CPU 11 of the portable terminal 8 may determine that a desired date is selected when a user only taps the desired date or may determine that the desired date is selected when the user operates the “receipt inquiry” button B1 after tapping the desired data.

Further, as shown in FIG. 14, the display example X includes a “campaign” button B2 for transitioning to an application type campaign page.

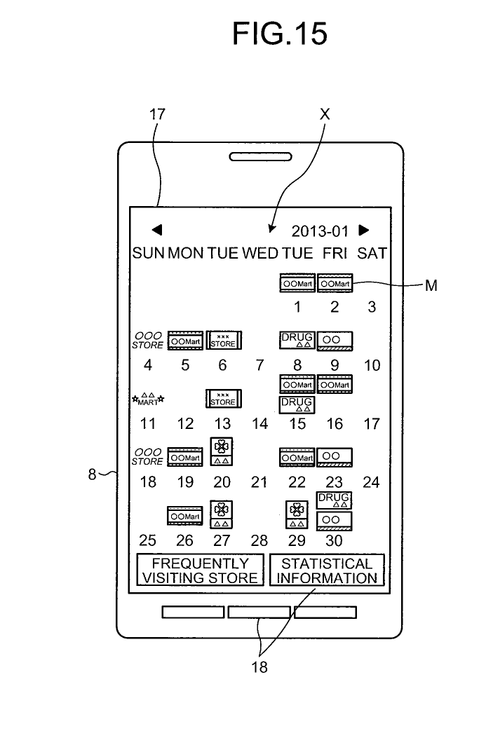

FIG. 15 is a modification of the display example X. In the display example X shown in FIG. 15, by adding a mark M and the like of stores of various companies to dates when the user owning the portable terminal 8, which accesses the electronic receipt management server 9, performed shopping in the stores of the companies, it is possible to intuitively grasp the stores where the user performed shopping. That is, with the display example X shown in FIG. 15, it is possible to easily learn information concerning in stores of which companies the user frequently performs shopping. In order to display the mark M of the stores, a table for associating marks with company codes included in the electronic receipt information in advance is prepared.

If the CPU 11 (the electronic-receipt display unit 83) of the portable terminal 8 determines that the user taps and selects a desired date (Yes in Act 34), the CPU 11 displays electronic receipt information corresponding to the selected date on the display unit 17 (Act 35).

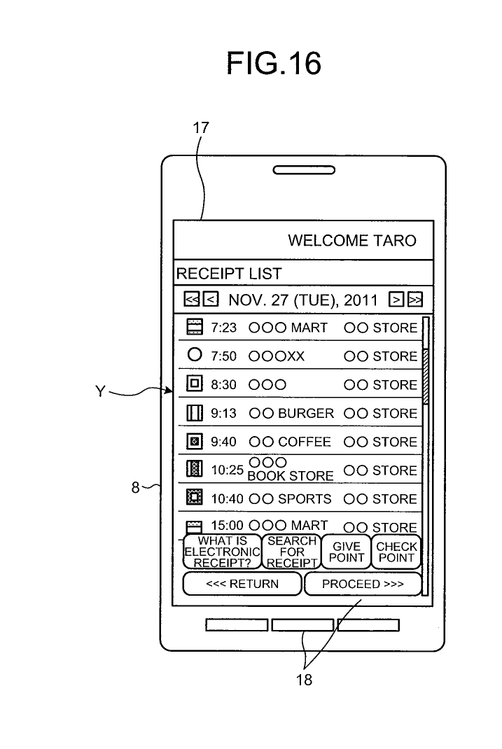

FIG. 16 is a front view showing a display example Y in the portable terminal. As shown in FIG. 16, in the display example Y, stores of various companies where the user owning the portable terminal 8, which accesses the electronic receipt management server 9, performed shopping are displayed as a list for each of dates. More specifically, in the display example Y, the stores are displayed in chronological order in the order of reception of the electronic receipt information. Company marks, transaction times, company names, and store names are displayed. The CPU 11 (the electronic-receipt display unit 83) of the portable terminal 8 performs display such that a desired store in each of dates can be selected by a cursor, which follows an input to the operation unit 18, out of store information for each of the dates displayed as the list.

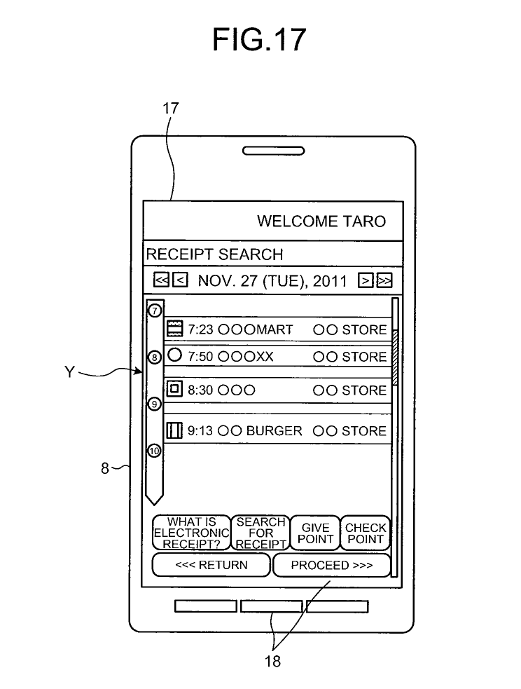

FIG. 17 is a modification of the display example Y. In the display example Y shown in FIG. 17, a “time bar” in which time is displayed at a fixed time interval is arranged. In the example shown in FIG. 17, the fixed time interval is one hour interval. Since electronic receipt information is displayed at the fixed time interval in this way, it is easy to image a situation of blank time when the electronic receipt information is not displayed.

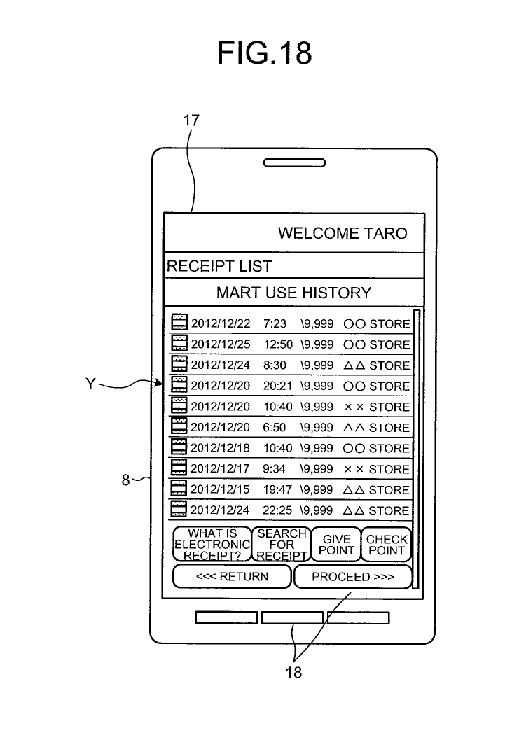

FIG. 18 is also a modification of the display example Y. In the display example Y shown in FIG. 18, only a use history in stores of a specific company is sorted and displayed as a list in chronological order by touching a company mark of the display example Y. By displaying only frequently used stores of a company as a list, it is easy to grasp a use situation.

If the CPU 11 (the electronic-receipt display unit 83) of the portable terminal 8 determines that the user selects a desired store in each of dates (Yes in Act 36), the CPU 11 displays electronic receipt information corresponding to the selected store in each of dates on the display unit 17 (Act 37).

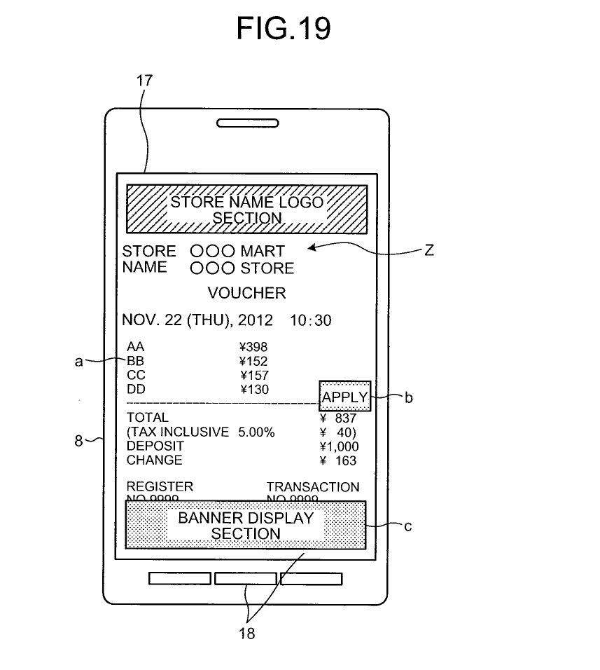

FIG. 19 is a front view showing a display example Z in the display unit 17 of the portable terminal 8. As shown in FIG. 19, in the display example Z, electronic receipt information of a desired store in a desired date when the user owning the portable terminal 8, which accesses the electronic receipt management server 9, performed shopping is shown. In the display example Z, the electronic receipt information is analyzed and displayed in a layout same as a paper receipt. In the display example Z, a commodity “a” or an icon “b” (a button-shaped icon “application” in FIG. 19) for instructing a start of processing for application for various kinds of additional information (e.g., campaign information) associated with the commodity is focused, selected, and operated by a cursor, which follows an input to the operation unit 18.

A screen display image does not always need to be a receipt image. However, in the display example Z, in order to use for presentation to a store when there is a returned commodity, the following information is displayed:

Store name

Purchase date and time

Purchased commodity details

Sales total amount

Register number

Transaction number

If the user selects an appropriate commodity or an icon associated with the commodity (Yes in Act 38), the CPU 11 (the electronic-receipt display unit 83) of the portable terminal 8 connects to the network 5 via the network interface 14, acquires various kinds of information based on access information associated with the selected commodity or icon from the network 5, and displays the information on the display unit 17 (Act 39).

For example, if a Web page associated with the commodity “a” as access information to the commodity “a” is set as an information link, when a desired commodity is selected, the Web page associated with the commodity “a” is displayed on the display unit 17.

If a Web page associated with an application campaign as access information is set for the button-shaped icon “b” “application”, when the button-shaped icon “b” “application” is selected, a page of an application type campaign associated with the icon “b” is displayed on the display unit 17.

There has been, as a campaign of a company, an application type campaign in which a campaign sticker (a purchase certificate) is affixed to a campaign target commodity and a shopper inputs a sticker number described on the campaign sticker to an application page designated by a URL and applies for the campaign.

On the other hand, the electronic receipt system in this embodiment makes it unnecessary to affix a campaign sticker (a purchase certificate) to a campaign target commodity, uses a purchase certificate obtained by digitizing commodity sales data included in electronic receipt information, and enables a consumer product manufacturer and the like to obtain the electronic receipt information, which is the digitized purchase certificate. A user who purchases the campaign target commodity can apply for the campaign and can correctly perform measurement of an effect of the campaign. Since the button-shaped icon “b” “application” is displayed on a display screen of an electronic receipt, it is possible to inform a user, who is unaware of the campaign, of the campaign and improve the effect of the campaign.

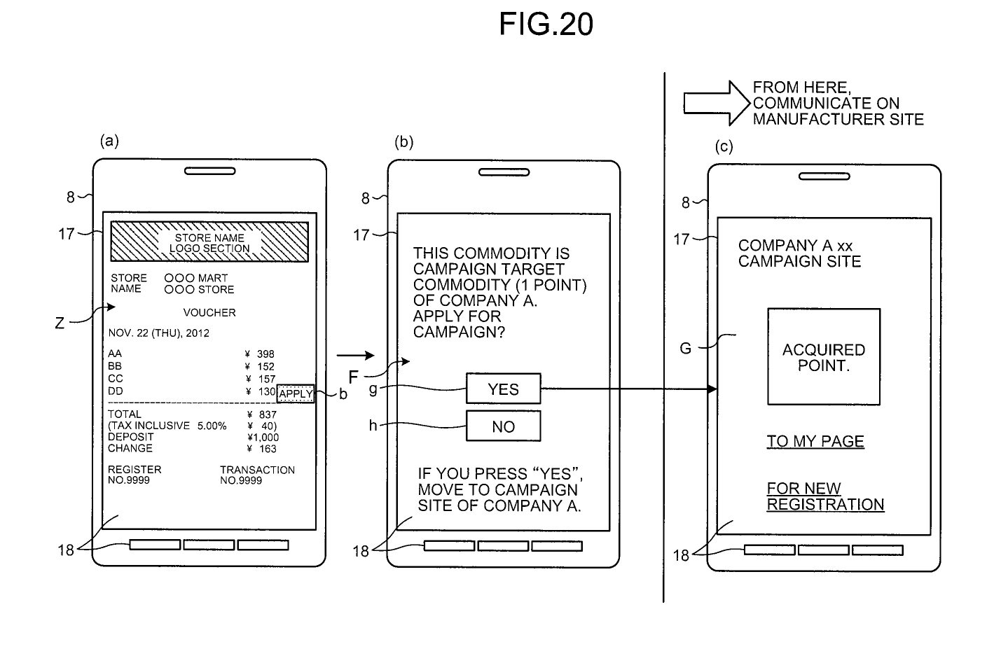

A flow of campaign application processing executed by the CPU 11 of the portable terminal 8 operating according to the campaign application program P13 started according to the selection of the button-shaped icon “b” “application” is explained with reference to screen transition charts of FIGS. 20A to 20C.

The button-shaped icon “b” “application” may be limitedly provided with a selected number of times (e.g., only once). In this case, an entry master of the promotion management server 10, which manages an application history for each of campaign types in association with a member code, only has to be referred to.

FIGS. 20A to 20C are screen transition charts showing the flow of the campaign application processing. In the display example Z shown in FIG. 20A, as explained with reference to FIG. 19, electronic receipt information of a desired store in a desired date when the user owning the portable terminal 8, which accesses the electronic receipt management server 9, performed shopping is displayed.

If the button-shaped icon “b” “application” shown in FIG. 20A is operated, the CPU 11 of the portable terminal 8 causes the display unit 17 to display an application screen F as shown in FIG. 20B. On the application screen F shown in FIG. 20B, a “YES” button “g” for instructing a start of processing for campaign application and a “NO” button “h” for instructing not to perform campaign application are displayed.

If the “YES” button “g” shown in FIG. 20B is operated, the CPU 11 of the portable terminal 8 causes the display unit 17 to display a campaign site G on a manufacturer side shown in FIG. 20C and attract a customer to the campaign site G on the manufacturer side.

In the campaign application, the CPU 11 (the application unit 84) of the portable terminal 8 generates a unique serial number and transmits the serial number to the manufacturer side in addition to a signal representing the campaign application and transmits the unique serial number to the promotion management server 10 as well. In addition, the CPU 11 of the portable terminal 8 transmits, as application data, information indicating the application for the campaign and the unique serial number to the electronic receipt management server 9. The unique serial number is formed by, for example, the following data:

Serial number→CCCSSSRRRIIIYYYYMMDDHHMMID
CCC→ . . . mart (company code)
SSS→ . . . store (store code)
RRR→Register number
III→JAN+serial number code
YYYY→2012 (year)
MM→11 (month)
DD→27 (day)
HH→07 (hour)
MM→23 (minute)
ID→ID of a member

The “III” portion of the code is formed by JAN+serial number code. For example, if one commodity specified by a certain JAN code is purchased, the serial number code is “1”. If three commodities are purchased, the serial number code is “3”. That is, the unique serial number functions as electronic purchase certification information for certifying how many commodities specified by the serial number a consumer purchases. The serial number can be arbitrarily set to include a company code for specifying a company, a store code for specifying a store, and data of month, day, hour, and minute for specifying date and time when a commodity is purchased. That is, the application unit 84 includes a purchase-certification-information output unit configured to output purchase certification information related to electronic receipt information.

By transmitting the serial number to the electronic receipt management server 9, the electronic receipt management server 9 can manage application data for each of campaigns using the serial number. With the recording of the application, the electronic receipt management server 9 can calculate a campaign effect such as a ratio of commodity sales and application.

By transmitting the serial number to the manufacturer side, it is possible to carry out a campaign (a promotion) limited to a predetermined company, limited to a predetermined district, limited to a predetermined time, or the like.

That is, purchase certification (evidence) information in units of a receipt is immediately transmitted to the manufacturer side. The manufacturer side, which plans the campaign, performs management of campaign application. As a result, several effects are obtained as explained below.

It is possible to arouse an action for immediate application at a point of purchase. Whereas a user visits the campaign site G on the manufacturer side only after a certain degree of points are saved in the past, there is an advantage that attraction to a site on the manufacturer side is immediately realized at a point of purchase. Further, the user visits the campaign site G on the manufacturer side many times every time the user purchases a commodity.

It is possible to transmit information in units of a receipt to the manufacturer on a real time basis in association with an application action. Since data of a serial number including date and a purchase store can be transmitted together with the application action, it is possible to determine a relation between the campaign and a period of open to media and a difference in the number of applications depending on a store on a real time basis. This tends to lead to support measures during a campaign period.

For example, if the manufacturer side performs a campaign of an instant win type, it is necessary to immediately perform a lottery in units of one lot in any case. However, by performing management of campaign application on the manufacturer side that plans the campaign, a system for saving points is unnecessary on the promotion management server 10 side.

From the user side, there is an advantage that labor and time are saved because an input of serial numbers of stickers, which are currently input one by one, can be performed by one click.

As explained above, the CPU 11 causes the display unit 17 to display the campaign site G on the manufacture side and attract a customer to the campaign site G on the manufacturer side and transmits the signal representing the campaign application and the purchase certification information to the manufacturer side. Consequently, it is possible to improve the effect of the campaign.

In the screen transition charts of the campaign application processing shown in FIGS. 20A to 20C, if the “application” icon “b” shown in FIG. 20A is operated, the application screen F shown in FIG. 20B is displayed. However, the screen transition is not limited to this. If the “application” icon shown in FIG. 20A is operated, the campaign site G on the manufacturer side shown in FIG. 20C may be displayed on the display unit 17 without the application screen F shown in FIG. 20B being displayed. At this point, according to the operation of the “application” icon “b” shown in FIG. 20A, the CPU 11 of the portable terminal 8 generates a unique serial number and transmits the unique serial number to the manufacturer side in addition to the signal representing the campaign application and transmits the unique serial number to the promotion management server 10 as well. In addition, the CPU 11 of the portable terminal 8 transmits information indicating the application for the campaign and the unique serial number to the electronic receipt management server 9 as application data. The unique serial number functions as electronic purchase certification information for certifying how many commodities specified by the serial number a consumer purchases.

If a Web page associated with a CM as access information is set for a banner “c”, which is a type of the icon shown in FIG. 19, when the banner “c” is selected, the CM associated with the banner “c” is displayed on the display unit 17.

If an end of the electronic receipt viewing processing is declared from the operation unit 18 (Yes in Act 40), the CPU 11 of the portable terminal 8 ends the processing.

If the end of the electronic receipt viewing processing is not declared from the operation unit 18 (No in Act 40), the CPU 11 of the portable terminal 8 returns to Act 38 and stands by for selection of a commodity or an icon associated with the commodity.

If the button-shape icon “b” “application” shown in FIG. 20A is operated, points may be saved in the promotion management server 10.

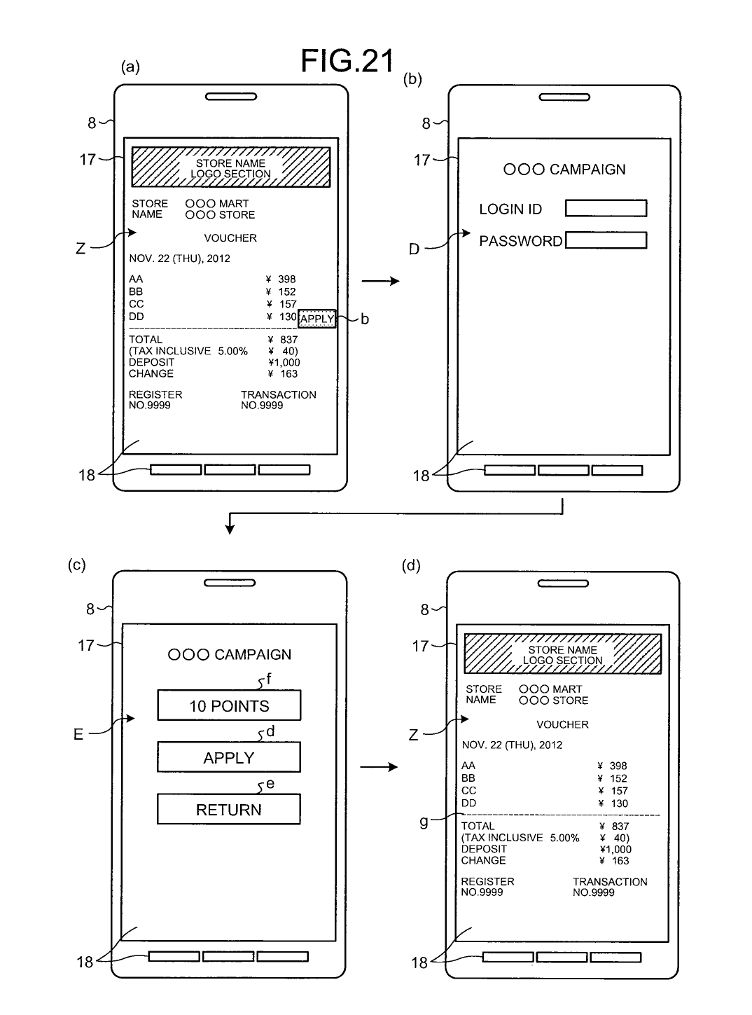

FIGS. 21A to 21D are screen transition charts showing a flow of another kind of campaign application processing. In the display example Z shown in FIG. 21A, as explained with reference to FIG. 19, electronic receipt information of a desired store in a desired date when the user owning the portable terminal 8, which accesses the electronic receipt management server 9, performed shopping is displayed.

If the button-shaped icon “b” “application” shown in FIG. 21A is operated, the CPU 11 of the portable terminal 8 starts processing for application for an application type campaign. First, the CPU 11 of the portable terminal 8 determines whether a customer does not enter in the application type campaign associated with the icon “b” yet.

If the CPU 11 of the portable terminal 8 determines referring to the entry master of the promotion management server 10 that the customer does not enter in the application type campaign associated with the icon “b” yet, the CPU 11 executes entry processing.

In the entry processing for the application type campaign, the CPU 11 displays an entry screen on the display unit 17 of the portable terminal 8 and issues a “login ID” and a “password”. The CPU 11 issues the “login ID” and the “password” according to the same procedure as the member registration for the customer explained with reference to FIG. 2. The customer transmits a blank mail from the portable terminal 8 to the promotion management server 10 through the network 5. The promotion management server 10 transmits a URL (Uniform Resource Locator) indicating a page for entry to a received mail address. The customer accesses the URL indicating the page for entry from the portable terminal 8, whereby the CPU 11 of the portable terminal 8 causes the display unit 17 to display an entry screen. The customer inputs items necessary for entry to the entry screen displayed on the display unit 17 of the portable terminal 8. After input confirmation by the customer, registration in the entry master of the promotion management server 10 is executed.

If the entry processing is executed or the CPU 11 of the portable terminal 8 determines referring to the entry master of the promotion management server 10 that the customer enters in the application type campaign associated with the icon “b” already, the CPU 11 causes the display unit 17 to display a login screen D shown in FIG. 21B. The customer inputs the “login ID” and the “password” to the login screen D displayed on the display unit 17 of the portable terminal 8.

After login authentication, the CPU 11 (the application unit 84) of the portable terminal 8 executes application processing for the promotion management server 10. The application processing is, for example, processing for adding up, as one point, one selection of the button-shaped icon “b” “application”. In such a case, as shown in FIG. 21C, the CPU 11 of the portable terminal 8 causes the display unit 17 to display an application screen E. On the application screen E shown in FIG. 21C, a number-of-points display section “f” in which the number of points accumulated in the promotion management server 10 is displayed, an application button “d” for instructing a start of processing for campaign application according to the number of points, and a return button “e” for keeping the points accumulated.

The number of points displayed in the number-of-points display section “f” of the application screen E shown in FIG. 21C is not limited to the number of points accumulated for each of target commodities. For example, the number of points may be the number of points accumulated for each of manufacturers or may be the number of points accumulated for each of brands.

The application processing is not limited to, for example, processing for adding up, as one point, one selection of the button-shaped icon “b” “application” and may be processing in which a given point is different for each of target commodities; for example, a given point for a target commodity B is one point and a given point for a target commodity C is two points.

If the application button “d” shown in FIG. 21C is operated, the CPU 11 of the portable terminal 8 transmits to the promotion management server 10 the effect that the accumulated number of points is used for the campaign application and returns to the display example Z shown in FIG. 21D. In the display example Z shown in FIG. 21D, the button-shaped icon “b” “application” shown in FIG. 21A is not displayed and is changed to an inoperable state. In the display example Z shown in FIG. 21D, the button-shaped icon “b” “application” may be grayed out and changed to the inoperable state.

In the campaign application, the CPU 11 of the portable terminal 8 transmits a unique serial number to the promotion management server 10 in addition to a signal indicating that the accumulated number of points is used for the campaign application.

By transmitting the serial number to the promotion management server 10, it is possible to carry out a campaign (a promotion) limited to a predetermined company, limited to a predetermined district, limited to a predetermined time, or the like.

If the return button “e” shown in FIG. 21C is operated, the CPU 11 of the portable terminal 8 directly returns to the display example Z shown in FIG. 21D. In this case, as in the case explained above, in the display example Z shown in FIG. 21D, the button-shaped icon “b” “application” shown in FIG. 21A is not displayed.

As explained above, with the electronic receipt system in this embodiment, the consumer product manufacturer or the like can carry out, under a specific condition in which electronic receipt information is used, a sales promotion that has to target an unspecified large number of people in the past. The specific condition is, for example, “limited to a specific company that operates stores”, “limited to a specific district”, “limited to a specific time”, or the like.

With the electronic receipt system in this embodiment, the consumer product manufacturer or the like acquires, from the electronic receipt information, unique certification information of a purchased commodity related to the manufacturer. Therefore, it is possible to substantially reduce sales promotion expenses required for a campaign.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

For example, as a modification of the embodiment, the POS terminal 2, which is a commodity sales data apparatus, may include the functions of the electronic receipt management server 9 explained above. The configuration of this modification is explained below. Components same as the components in the embodiment are denoted by the same reference numerals and signs and explanation of the components is omitted.

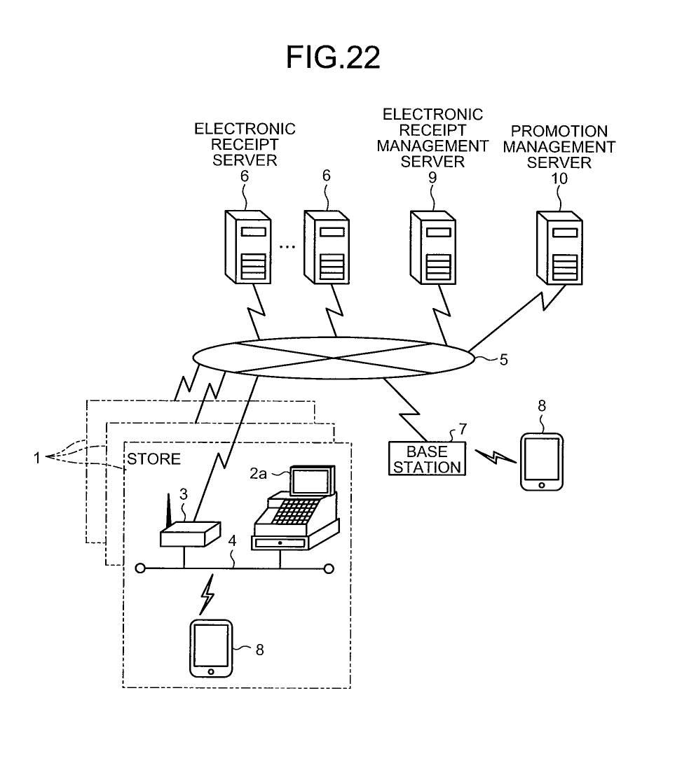

FIG. 22 is a configuration diagram showing the overall configuration of an electronic receipt system according to this modification. As shown in FIG. 22, in the store 1, a POS terminal 2a (only one terminal 2a is shown in FIG. 22, however, a plurality of terminals 2a may be provided), which is a commodity sales data processing apparatus according to this modification, and a router 3 are set. The POS terminal 2a and the router 3 are connected by the store LAN 4. The portable terminal 8 can connect to the store LAN 4 in this modification via an access point (not shown in the figure) that performs radio communication according to a standard such as Wi-Fi (Wireless Fidelity). That is, the portable terminal 8 communicates with the POS terminal 2a through the store LAN 4.

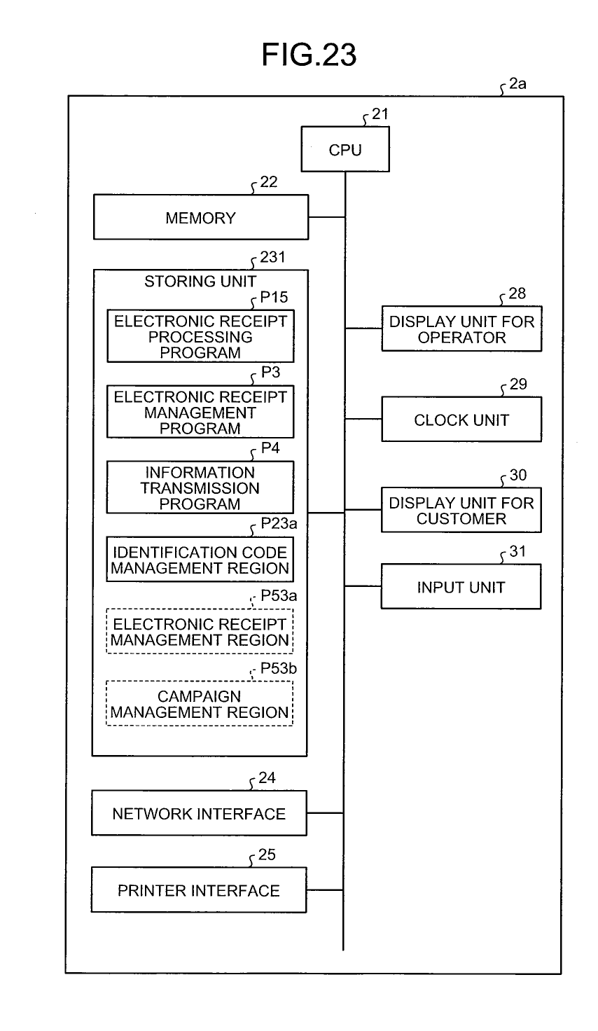

In the electronic receipt system having the configuration, the POS terminal 2a includes the main part configuration shown in FIG. 23. FIG. 23 is a block diagram showing the main part configuration of the POS terminal 2a, which is a commodity sales data processing apparatus. As shown in FIG. 23, the POS terminal 2a includes the CPU 21, the memory 22, a storing unit 231, the network interface 24, the printer interface 25, the display unit for operator 28, the clock unit 29, the display unit for customer 30, and the input unit 31.

The storing unit 231 is installed in advance with, besides software for executing various POS jobs including the commodity sales data processing, the electronic receipt processing program P15, the electronic receipt management program P3, and the information transmission program P4.

In the storing unit 231, the identification code management region 23a is secured in which, in addition to a POS number of the POS terminal 2a, a company code, a business type and business status code, a store code, and the like are stored. In the storing unit 23, the electronic receipt management region 53a and the campaign management region 53b may be secured.

The electronic receipt processing program P15, the electronic receipt management program. P3, and the information transmission program P4 executed by the POS terminal 2a are provided while being recorded in a computer-readable recording medium such as a CD-ROM, a flexible disk (FD), a CR-R, or a DVD (Digital Versatile Disk) as a file in an installable or executable form.

The electronic receipt processing program P15, the electronic receipt management program. P3, and the information transmission program P4 executed by the POS terminal 2a may be stored on a computer connected to a network such as the Internet and provided by being downloaded through the network. The electronic receipt processing program. P15, the electronic receipt management program P3, and the information transmission program P4 executed by the POS terminal 2a may be provided or distributed through the network such as the Internet.

The operation of the POS terminal 2a in this modification is explained. The functional configuration and a flowchart of electronic receipt management processing executed by the CPU 21 of the POS terminal 2a operating according to the electronic receipt management program P3 and commodity information transmission processing executed by the CPU 21 of the POS terminal 2a operating according to the information transmission program P4 are the same as the functional configuration and the flowchart of FIGS. 10 and 11.

In this modification, if the storing unit 23 of the POS terminal 2a includes the electronic receipt management region 53a and the campaign management region 53b, the electronic-receipt managing unit 56, the electronic-receipt transmitting unit 57, and the additional-information managing unit 58 function as an access unit.

If the storing unit 23 does not include the electronic receipt management region 53a and the campaign management region 53b, the receiving unit 55, the electronic-receipt managing unit 56, and the additional-information managing unit 58 may not be generated. In the case of this configuration, the electronic-receipt transmitting unit 57 functions as the access unit. The electronic-receipt transmitting unit 57 acquires, from the electronic receipt management region 53a of the electronic receipt management server 9, electronic receipt information associated with a member code of a predetermined shopper and including at least one or more company codes and additional information (campaign information) related to commodity information and a specific condition included in the electronic receipt information and transmits the electronic receipt information and the additional information to the portable terminal 8 associated with the member code.

The receiving unit 55 of the POS terminal 2a receives application data (purchase certification information) for the campaign information generated on the basis of the electronic receipt information from the portable terminal 8 and stores the application data in the campaign management region 53b secured in the storing unit 23 of the POS terminal 2a or the campaign management region 53b secured in the storing unit 53 of the electronic receipt management server 9. Application data stored in the campaign management region 53b of the POS terminal 2a is preferably transmitted to the electronic receipt management server 9 or the like later in order to aggregate data.

With the configuration explained above, the POS terminal 2a includes functions equivalent to the functions of the electronic receipt management server 9. Therefore, a user of the portable terminal 8 can enjoy a service same as the service in the embodiment by accessing the POS terminal 2a through the store LAN 4 in the store 1.

What is claimed is:

1. An electronic receipt system comprising:
an electronic-receipt generating unit configured to generate, in association with a code of a shopper, electronic receipt information related to commodity sales data;
an electronic-receipt managing unit configured to store the electronic receipt information generated by the electronic-receipt generating unit in a storing unit;
an additional-information managing unit configured to store additional information associated with commodity information and a specific condition in the storing unit;
an electronic-receipt transmitting unit configured to transmit, to an information processing apparatus associated with the code of the shopper, the electronic receipt information associated with the code and the additional information related to the commodity information included in the electronic receipt information;
an electronic-receipt display unit configured to display the electronic receipt information transmitted to the information processing apparatus by the electronic-receipt transmitting unit and display a selectable object for instructing a start of processing for the additional information associated with the commodity information included in the electronic receipt information; and
a processing unit configured to transmit, if the selectable object displayed by the electronic-receipt display unit is operated, a start signal for the processing for the additional information.

2. The system according to claim 1, wherein the processing unit includes a purchase-certification-information output unit configured to output, if the selectable object is operated, purchase certification information related to the electronic receipt information.

3. The system according to claim 1, wherein
the additional information is campaign information, and
if the selectable object is operated, the processing unit transmits a start signal for processing for application for the campaign information.

4. The system according to claim 1, wherein, if the selectable object is operated via the operation unit, the electronic-receipt display unit changes the selectable object displayed on the display unit to an inoperable state.

5. An electronic receipt management server comprising:
a receiving unit configured to receive electronic receipt information related to commodity sales data;
an electronic-receipt managing unit configured to store the electronic receipt information received by the receiving unit in a storing unit;
an additional-information managing unit configured to store additional information associated with commodity information and a specific condition in the storing unit; and
an electronic-receipt transmitting unit configured to transmit, to an information processing apparatus associated with a code of a shopper, the electronic receipt information associated with the code and the additional information related to the commodity information included in the electronic receipt information.

6. The server according to claim 5, wherein, if the receiving unit receives purchase certification information for the additional information from the information processing apparatus, the receiving unit stores the purchase certification information in the storing unit.

7. The server according to claim 5, wherein the specific condition is a specific company that operates stores.

8. The server according to claim 5, wherein the specific condition is a specific district.

9. The server according to claim 5, wherein the specific condition is a specific store.

10. The server according to claim 5, wherein the specific condition is a specific time.

11. An information processing apparatus comprising:
an electronic-receipt receiving unit configured to receive electronic receipt information related to commodity sales data and additional information associated with commodity information and a specific condition included in the electronic receipt information from an electronic receipt management server that stores the electronic receipt information;
an electronic-receipt display unit configured to display the electronic receipt information received by the electronic-receipt receiving unit on a display unit and display a selectable object for instructing a start of processing for the additional information associated with the commodity information and the specific condition included in the electronic receipt information on the display unit; and
a processing unit configured to transmit, if the selectable object displayed by the electronic-receipt display unit is operated via an operation unit, a start signal for the processing for the additional information.

12. The apparatus according to claim 11, wherein the processing unit includes a purchase-certification-information output unit configured to output, if the selectable object is operated, purchase certification information related to the electronic receipt information.

13. The apparatus according to claim 11, wherein, if the selectable object is operated via the operation unit, the electronic-receipt display unit changes the selectable object displayed on the display unit to an inoperable state.
